(19) United States
(12) Patent Application Publication
(10) Pub. No.: US 2025/0242758 A1
(43) Pub. Date: Jul. 31, 2025

(54) VEHICLE DROP-DOWN STORAGE AREA

(71) Applicant: Bombardier Recreational Products, Inc., Valcourt (CA)

(72) Inventors: Antoine BILODEAU, Saint-François-Xavier-de-Brompton (CA); Remi LARROUY, Drummondville (CA); Matthew PEYTON, Sherbrooke (CA); Sebastien POISSANT, Sherbrooke (CA)

(21) Appl. No.: 18/823,062

(22) Filed: Sep. 3, 2024

Related U.S. Application Data
(60) Provisional application No. 63/626,346, filed on Jan. 29, 2024.
(60) Provisional application No. 63/626,343, filed on Jan. 29, 2024.

(51) Int. Cl. B60R 5/04

(52) U.S. Cl. CPC B60R 5/044

(57) ABSTRACT

A drop-down space for a vehicle may comprise a floor located internally of the vehicle, a wall extending upwardly from the floor, whereby the floor and the wall enclose a cavity located internally of the vehicle and at least one coupling mechanism for stably connecting a first article to the vehicle via the cavity. The wall of the cavity circumscribes at least a portion of the article when the article is interconnected to the vehicle.

### CROSS REFERENCE TO RELATED APPLICATIONS

This application claims the benefit of priority to U.S. Provisional Application No. 63/626,343 filed Jan. 29, 2024 and U.S. Provisional Application No. 63/626,346 filed Jan. 29, 2024, the subject matter of each of which being incorporated herein by reference in its entirety.

### FIELD OF THE INVENTION

The present invention relates to improvements in storage compartments for vehicles designed to traverse rough and/or uneven terrain, such as snowmobiles, ATVs, personal watercraft, and the like.

### BACKGROUND

Recreational vehicles may often have drop down areas in their frames and/or their cowlings. An exemplary drop-down area may be defined as an area in the frame or cowling that can encompass a vacant space within the vehicle but has a bottom surface that is closer to the ground than one or more of the rear fender and/or the top surface of the seat. In an exemplary use case, an exemplary drop-down area may be used for transporting cargo and accessories.

However, in circumstances where the cargo or accessory is not able to be stably held in the drop-down space, the cargo or accessory may be subjected to forces that can damage the container body of the cargo, any contents stored therein, the accessory internal/external componentry, or a combination of these.

### SUMMARY

An exemplary recreational vehicle storage system may comprise a drop-down space defined by a plurality of walls internal of the vehicle and a floor that is located below an uppermost surface of the seat of a vehicle. According to one exemplary aspect of the recreational vehicle storage system, the floor may be located forward of the steering assembly and/or rearward of the seat. The aforementioned vehicle storage system may further comprise at least one coupling mechanism configured to releasably couple a first article thereto so that the at least one coupling mechanism is found on either the floor, at least one of the plurality of walls, an adaptor configured to be interconnected to the vehicle, a work surface of the adaptor, or another article already disposed in the drop-down space.

In addition to the previously described embodiment and/or as an alternative to any other described exemplary embodiment, an exemplary vehicle storage system may be configured such that the at least one coupling mechanism is found on the adaptor.

In addition to the previously described exemplary embodiment, an exemplary vehicle storage system may further comprise an adaptor having a forward bracket body configured to couple the adaptor to the vehicle proximate a first wall, a rearward bracket body configured to couple the adaptor to the vehicle proximate a second wall, the first wall being opposite to the second wall, and a pair of work surfaces interconnecting the forward bracket body to the rearward bracket body. Accordingly, an exemplary forward bracket body, rearward bracket body, and pair of work surfaces may circumscribe at least a portion of the drop-down space.

In addition to the previously described exemplary embodiment, an exemplary vehicle storage system may further comprise

In addition to the previously described embodiment and/or as an alternative to any other described exemplary embodiment, an exemplary vehicle storage system may be configured such that one of the pair of work surfaces comprises the at least one coupling mechanism.

In addition to the previously described embodiment and/or as an alternative to any other described exemplary embodiment, an exemplary vehicle storage system may be configured such that the adaptor comprises at least one other coupling mechanism for stably connecting a second article to the vehicle above the first article.

In addition to the previously described embodiment and/or as an alternative to any other described exemplary embodiment, an exemplary vehicle storage system may be configured such that the forward bracket body is separable from the adaptor.

In addition to the previously described embodiment and/or as an alternative to any other described exemplary embodiment, an exemplary vehicle storage system may be configured such that at least a portion of the first article is disposed above the drop-down space.

In addition to the previously described embodiment and/or as an alternative to any other described exemplary embodiment, an exemplary vehicle storage system may be configured such that the first article is disposed above a second article in the drop-down space via the structure.

In addition to the previously described embodiment and/or as an alternative to any other described exemplary embodiment, an exemplary vehicle storage system may be configured such that at least one coupling mechanism is found on another article already disposed in the drop-down space.

In addition to the previously described embodiment and/or as an alternative to any other described exemplary embodiment, an exemplary vehicle storage system may be configured such that the at least one coupling mechanism is found on the work surface of the adaptor.

In addition to the previously described embodiment and/or as an alternative to any other described exemplary embodiment, an exemplary vehicle storage system may be configured such that the first article is disposed above the drop-down space via the structure, the structure being the work surface of the adaptor.

In addition to the previously described embodiment and/or as an alternative to any other described exemplary embodiment, an exemplary vehicle storage system may be configured such that the first article has at least one other portion that extends beyond the plurality of walls when disposed above the drop-down space.

In addition to the previously described embodiment and/or as an alternative to any other described exemplary embodiment, an exemplary vehicle storage system may be configured such that the first article is releasably couplable to one or more of the floor, the plurality of walls, and the adaptor.

In addition to the previously described embodiment and/or as an alternative to any other described exemplary embodiment, an exemplary vehicle storage system may be configured such that the first article is releasably couplable to only the adaptor.

In addition to the previously described embodiment and/or as an alternative to any other described exemplary embodiment, an exemplary vehicle storage system may further comprise a second drop-down space defined by a plurality of walls internal of the vehicle and a floor that is located below the seat of a vehicle and forward of the steering shaft of the vehicle.

In addition to the previously described embodiment and/or as an alternative to any other described exemplary embodiment, an exemplary vehicle storage system may be configured such that the adaptor is coupled to the second drop-down space and further comprises a latched hood that separates the pair of work surfaces.

In addition to the previously described embodiment and/or as an alternative to any other described exemplary embodiment, an exemplary vehicle storage system may be configured such that the first article is configured to be bounded by the hood when the hood is aligned with the pair of work surfaces.

In addition to the previously described embodiment and/or as an alternative to any other described exemplary embodiment, an exemplary vehicle storage system may be configured such that a second adaptor is coupled to the drop-down space and comprises at least one other coupling mechanism for stably connecting a second article to the vehicle that is disposed at a height that is above the first article.

In addition to the previously described embodiment and/or as an alternative to any other described exemplary embodiment, an exemplary vehicle storage system may further comprise at least one coupling mechanism configured to releasably couple a third article thereto.

In addition to the previously described embodiment and/or as an alternative to any other described exemplary embodiment, an exemplary vehicle storage system may further comprise at least one coupling mechanism is disposed on either the floor, at least one of the plurality of walls, a second adaptor configured to be coupled itself to the vehicle, a work surface of the second adaptor, or a fourth article already disposed in the drop-down space.

In addition to the previously described embodiment and/or as an alternative to any other described exemplary embodiment, an exemplary vehicle storage system may be configured such that the second adaptor comprises at least one other coupling mechanism for stably connecting a fourth article to the vehicle above the third article.

In addition to the previously described embodiment and/or as an alternative to any other described exemplary embodiment, an exemplary vehicle storage system may be configured such that the adaptor is coupled to the second drop-down space and further comprises a latched hood that separates the pair of work surfaces.

An exemplary system includes walls and a floor found below the upper surface of the seat of a recreational vehicle that enclose a drop-down space therein. According to an exemplary embodiment, the floor within the drop-down space may have one or more coupling mechanisms for an accessory to be attached. Additionally, or alternatively, an adaptor may be affixed to the vehicle via the walls or vehicle cowling to circumscribe the drop-down space. In an alternative aspect of this embodiment, the adaptor may also have one or more coupling mechanisms for accessories to be attached. In one configuration, a first accessory may be disposed within the drop-down space and coupled to the mechanisms for coupling found on the floor of that space while a second accessory may be coupled to the mechanisms for coupling found on the adaptor circumscribing the same space and be disposed above the first accessory. In either aspect, when an accessory is coupled to either of the floor or the adaptor, peripheral portions of such accessory may extend beyond the walls making up the drop-down space, in other words, the accessory may have a width that is larger than, and in some cases, substantially larger in width than, the drop-down space into which it may be placed. In additional aspects, an accessory may have means to couple it to coupling mechanisms in the floor of the drop-down space and/or an adaptor, but without a line-of-sight between the coupling means of the accessory and the coupling mechanism of the floor and/or the adaptor as the case may be. Therefore, another exemplary aspect of the systems disclosed herein are coupling mechanisms for accessories that enable them to connect to coupling mechanisms found on drop-down space floors, adaptors, and even coupling mechanisms located on portions of other accessories but without the user being able to see the coupling interaction. As such, the accessories may be configured so that they may be interconnected due to complementary geometry of the coupling mechanisms of the accessory and the other attachment surface (e.g., that of the drop-down space floor, the adaptor work surfaces, and/or another accessory). Additionally, and alternatively, accessories may interconnect to other accessories via their respective coupling mechanisms to enable a multi-accessory attachment to the vehicle via either of the drop-down space floor or the adaptor.

### DESCRIPTION OF THE DRAWINGS

FIG. 1 illustrates an exemplary vehicle with a drop-down space in the rear and an exemplary adaptor for use within the drop-down space to stably hold an exemplary piece of cargo therein.

FIG. 2 illustrates an exemplary drop-down space at the rear of an exemplary vehicle with an exemplary adaptor installed therein.

FIG. 3 illustrates an exemplary plan view of an exemplary rear drop-down space of a vehicle with an exemplary adaptor installed therein.

FIG. 4 illustrates an exemplary drop-down space at the front of an exemplary vehicle with an exemplary adaptor installed therein.

FIG. 5 illustrates an exemplary drop-down space at the front and rear of an exemplary vehicle with an exemplary adaptor installed in each as well as a cargo/accessory installed in the front of the vehicle via the front exemplary adaptor.

FIG. 6 illustrates an exemplary adaptor for installation in an exemplary drop-down space of an exemplary vehicle.

FIG. 6A illustrates an exemplary drop-down space at the rear of an exemplary vehicle with mechanical attachment points for installation of an exemplary adaptor and one or more accessories therein.

FIG. 6B illustrates an exemplary drop-down space at the rear of an exemplary vehicle with one arrangement of accessory attachment via attachment points in the drop-down space.

FIG. 6C illustrates an exemplary drop-down space at the rear of an exemplary vehicle with an alternative arrangement of accessory attachment via accessory attachment points.

FIG. 7 illustrates an exemplary cargo for use in conjunction with an exemplary adaptor for an exemplary drop-down space.

FIG. 8 illustrates the exemplary cargo of FIG. 7 placed within an installed exemplary adaptor for an exemplary drop-down space in the front of a vehicle.

FIG. 9 illustrates an exemplary drop-down space at the front and rear of an exemplary vehicle with an exemplary adaptor installed in each as well as a cargo/accessory installed in the rear of the vehicle via the rear exemplary adaptor.

FIG. 10 illustrates an exemplary drop-down space at the front and rear of an exemplary vehicle with an exemplary adaptor installed in each as well as a cargo/accessory installed in each.

FIGS. 11A-B illustrates additional cargo/accessories having configurations to be stably held within exemplary drop-down spaces without need for any adaptors.

FIG. 12 illustrates an exemplary drop-down space at the front of an exemplary vehicle with an exemplary adaptor installed as well as a cargo/accessory installed above and below the same.

FIG. 13 illustrates an exemplary drop-down space at the front of an exemplary vehicle with an exemplary adaptor, a cargo/accessory installed below the adaptor, an exemplary cargo/accessory configured to be installed above the adaptor, and a further adaptor wall component for coupling to the adaptor.

FIG. 14 illustrates an exemplary drop-down space at the rear of an exemplary vehicle with an exemplary cargo/accessory configured for direct coupling to the drop-down space without the need for an adaptor.

FIG. 15 illustrates an exemplary vehicle having an exemplary cargo/accessory coupled above a drop-down space at the front of the vehicle with or without an adaptor and an exemplary cargo/accessory coupled to the drop-down space at the rear of the vehicle with or without an adaptor.

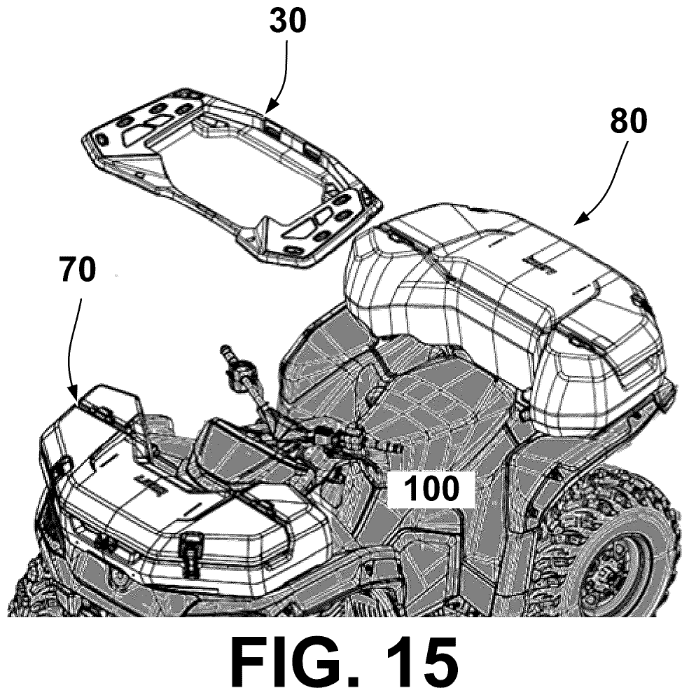

FIG. 16 illustrates an exemplary vehicle having one or more exemplary cargo/accessories and adaptors coupled below, to, and above exemplary drop-down spaces at the front and rear of the vehicle.

In the drawings like characters of reference indicate corresponding parts in the different and interchangeable and interrelated figures. Parts and components of each figure may be substitutes for other components in other figures to achieve the various methods and embodiments disclosed herein. Methods and protocols disclosed in any embodiment may be run in any order so as to affect their disclosed goals and/or enable performance of the systems as described. Additionally, any one embodiment may utilize any method or protocol described and in any portions, sequences, and combinations thereof.

### DETAILED DESCRIPTION

While the disclosures herein contemplate use in any drop-down environment in any vehicle, including recreational vehicles of the type previously indicated and/or known to those skilled in the art, the use of an all-terrain vehicle (“ATV”) is for illustration only and not limiting to the intended uses for which such disclosures can be put. An exemplary drop-down space located forward of the steering assembly of the vehicle is referred to herein as a forward drop-down space 50A while a drop-down space located rearward of the steering assembly of the vehicle is referred to herein as a rearward drop-down space 50B. While the disclosures herein may describe one or both of these spaces 50A and/or 50B, it should be understood that such disclosures apply equally to either space without limitation unless otherwise specified herein. Furthermore, the plurality of accessories to be referenced herein may be configured to be received in either of spaces 50A and/or 50B, as well as on top of or below any adaptors 30/40 configured to couple to the same.

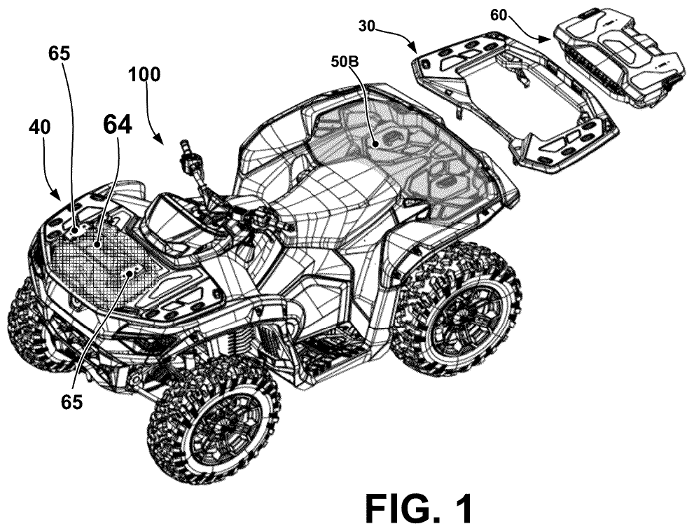

As provided for in FIG. 1, an exemplary vehicle 100, which may be illustrated as an ATV, may possess a drop-down space 50B into which an exemplary adaptor 30 may be installed by various mechanical means, including, but not limited to, snap-fit, screw-in joints, friction fit, ball and socket, Velcro®, clamps, belts, buckles, lock-and-key mechanisms, and others known to those skilled in the art. An exemplary drop-down space 50A and/or 50B may be comprised of one or more portions of the cowling of the vehicle 100. In a preferred embodiment, the cowling portions making up drop-down spaces 50A and/or 50B also form the wheel wells for vehicle 100. Alternatively, the drop-down space 50A and/or 50B may be formed from a combination of portions of the cowling of vehicle 100, frame of vehicle 100, and/or any other frame-supported structure of vehicle 100 to which objects can be rigidly attached during exemplary use of vehicle 100.

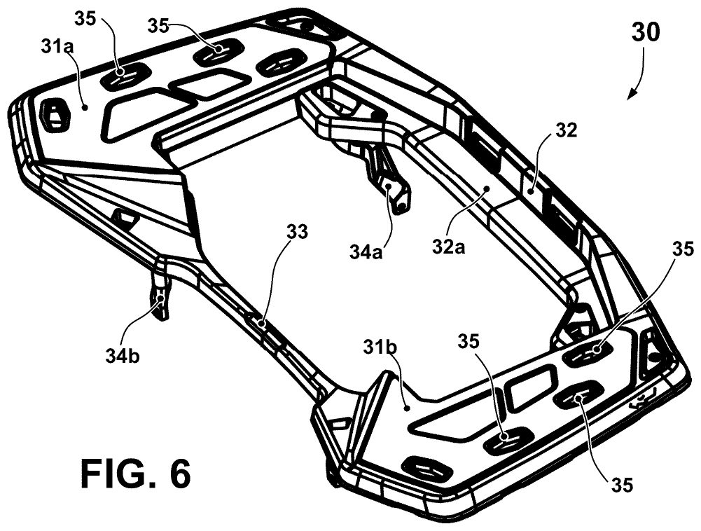

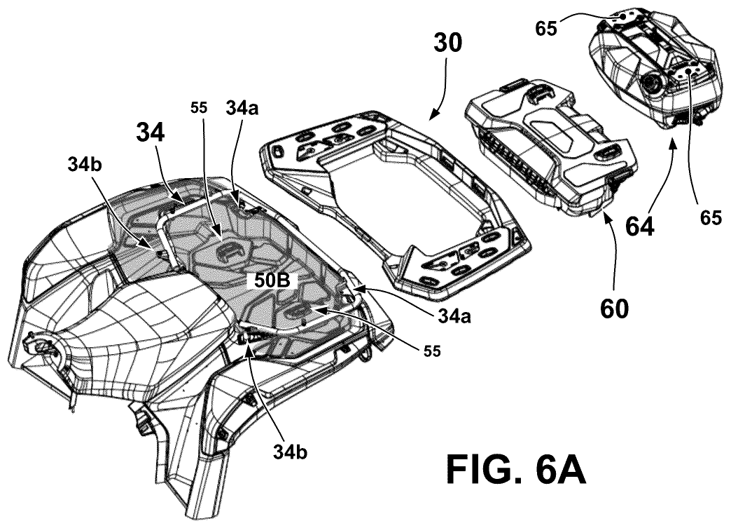

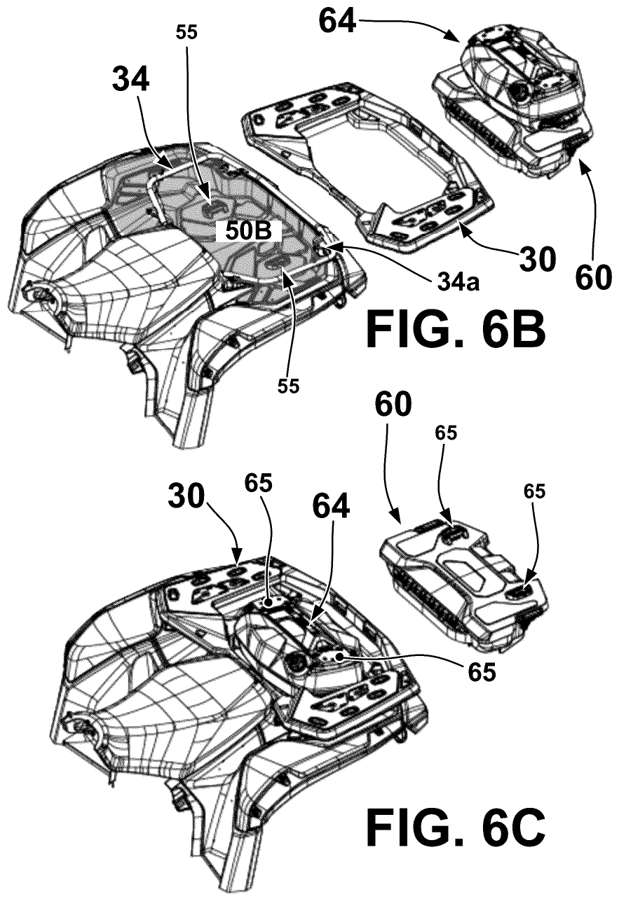

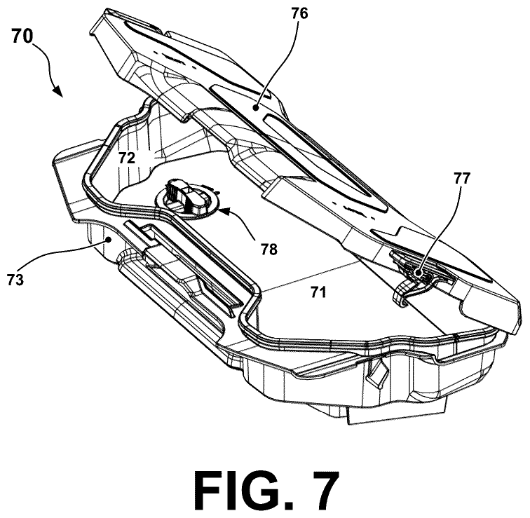

In a preferred embodiment, an exemplary adaptor 30 may be affixed to a portion of the cowling and/or frame of the vehicle 100 via quarter-turn fasteners or standard bolts. In an exemplary embodiment of a drop-down space adaptor 30, as may be illustrated by FIGS. 6, 6A-B, 9, 15, and 16, an exemplary adaptor 30 may have a left work surface 31a and a right work surface 31b interconnected to one another by a forward bracket body 32 and a rearward bracket body 33. In one embodiment, forward bracket body 32 may have surface structures 32a extending inwardly or outwardly from the same for receipt of specifically configured cargo/accessory 60/64/65. Additionally, legs 34a and 34b may extend downwardly from an adaptor scaffold 34. In an exemplary embodiment, legs 34a may extend downwardly from the portion of scaffold 34 disposed below forward bracket body 32 and legs 34b may extend downwardly from the portion of scaffold 34 disposed beneath rearward bracket body 33, as may be illustrated with respect to FIGS. 6A-B. Exemplary legs 34a and 34b of an exemplary adaptor 30 may serve as one of a variety of mechanical means of interconnecting the adaptor 30 to secure portions of vehicle 100 frame via either one or more walls of the drop-down space 50B and/or openings/gaps in the cowling of vehicle 100. As may be illustrated in FIGS. 6A-B, exemplary legs 34a and 34b may be bolted or otherwise mechanically secured to attachment points located in or on the drop-down space 50B that allow the adaptor 30 to interconnect to frame of vehicle 100 through the walls of drop-down space 50B (e.g., cowling or portions thereof). In a preferred embodiment, scaffold 34 and legs 34a/b may be made of a metal or robust plastic material whereas the body parts 31a, 31b, 32, 33, and 35 of an exemplary adaptor 30 are made of plastic.

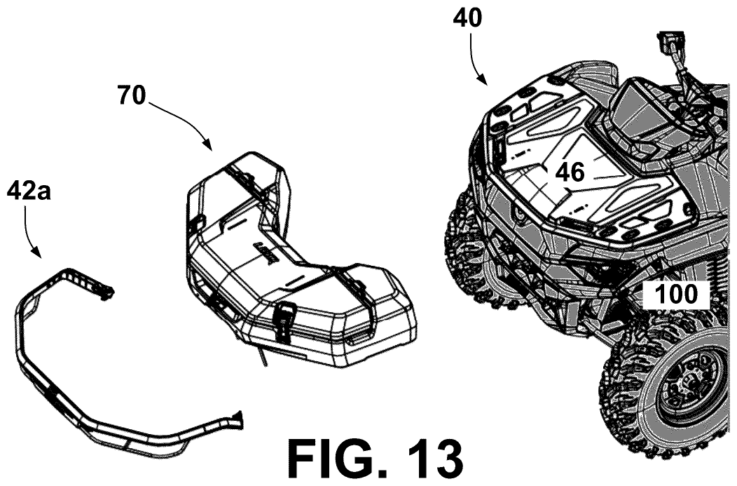

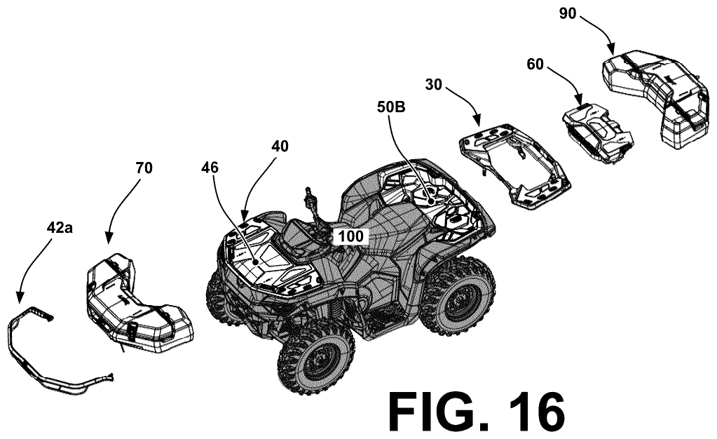

In an exemplary embodiment, adaptor 30 may also comprise one or more junctions 35 for receipt of known anchoring utilities for cargo/accessories, such as, for example, anchors commercially sold and produced under the trade name Linq™ by Bombardier Recreational Products Inc. of Valcourt, Quebec. Junctions 35 may also be fixturing openings for anchors and/or anchoring fixtures such as those disclosed in U.S. Pat. Nos. 9,511,704, 9,751,592, 10,787,216, 11,286,015, 11,427,283, 11,267,407, and 11,377,177, the anchor/anchor fixture disclosures of which being incorporated herein by reference in their entirety. While adaptor 30 for a rear drop-down space 50B of a vehicle 100 has been described, the above disclosures are equally applicable to an adaptor 40 for a front drop-down space 50A of the vehicle 100, as well as any other junctures disclosed herein (e.g., items 65). An exemplary adaptor 40 may have its work surfaces 41a/b, forward bracket body 42, rearward bracket body 43, and junctions 45. Further alternatively, as may be illustrated in FIGS. 13 and 16, an extension 42a may be coupled to an exemplary adaptor 40 to provide further points of attachment between an exemplary cargo/accessory and/or vehicle 100.

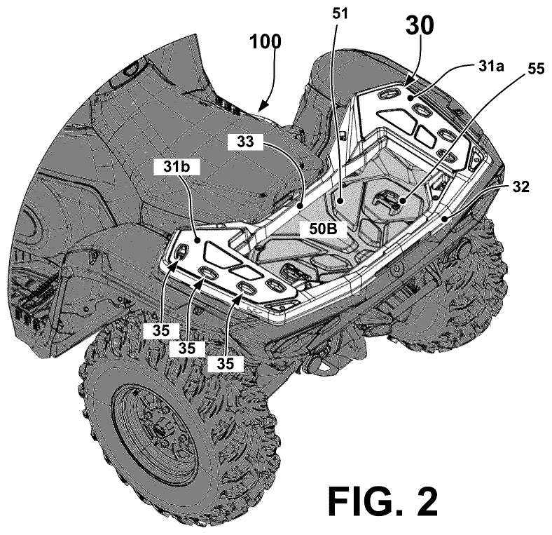

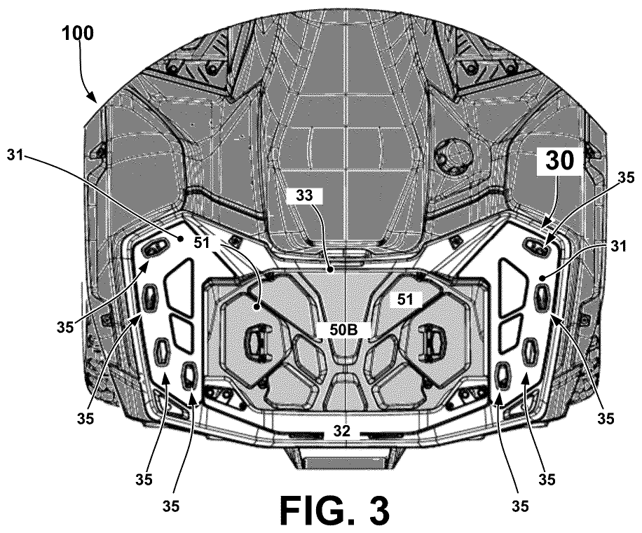

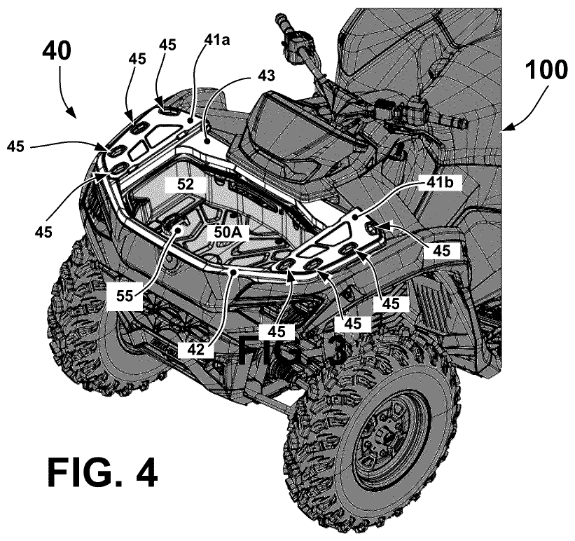

An exemplary adaptor 30 or 40 may be affixed to the frame and/or cowling of a vehicle 100 via the drop-down space 50A in the front of the vehicle 100 or the drop-down space 50B in the rear of the vehicle 100, respectively, as may be illustrated in FIGS. 2-4. When an exemplary adaptor 30 is affixed in the rear drop-down space 50B of a vehicle 100, the adaptor 30 is configured so that legs 32b and 33b along the periphery of the drop-down space 50B leaving exposed a bottom floor 51, walls 52, and, optionally, anchor/junctions 55 for connecting certain cargo/accessories 60/70/80 to the vehicle 100 directly. In an exemplary drop-down space 50B, floor 51 may be covered with a plastic liner to allow for a relatively flat and rigid structure. As may be illustrated in FIG. 2, an exemplary adaptor 30 may be mounted in a drop-down space 50B so that its rearward bracket body 33 may be disposed adjacent to and/or underneath a seat of vehicle 100. Alternatively, an exemplary adaptor 30 may otherwise be formed so that its rearward bracket 33 molds about pre-existing surfaces in the vehicle 100 when residing within drop-down space 50B. Similarly, as may be illustrated with respect to FIGS. 4, 9, and 11A for example, an exemplary adaptor 40 may be mounted in a drop-down space 50A so that its rearward bracket body 43 may be disposed about the steering console of the vehicle 100 and/or seamlessly with the rest of the vehicle and/or wheel cover cowlings.

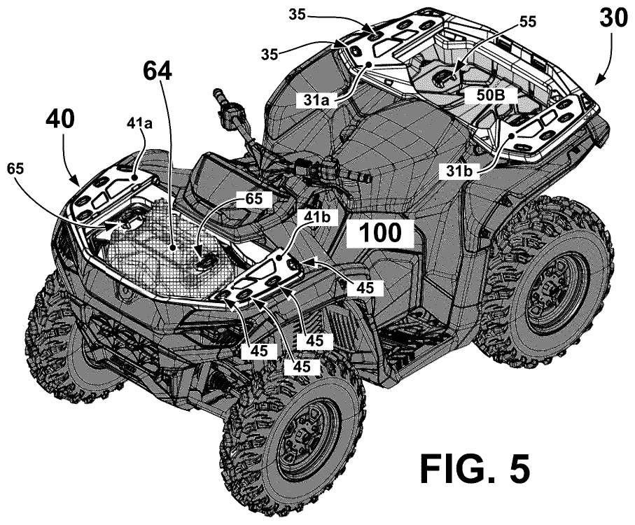

With reference to FIG. 1, an exemplary drop-down space 50A may contain within its adaptor 40 at the front of vehicle 100 an exemplary accessory 64, which itself possesses a pair of adaptor junctions 65 thereon. Exemplary adaptor junctions 64 may be the same or equivalent to the junctions 55 within an exemplary drop-down space 50A/50B. A similar illustrative example of such an exemplary arrangement of accessory 64 in a front drop-down space 50A may be further understood with reference to FIG. 5. In a preferred embodiment, an exemplary accessory 64 may be a jerry can or other like fluid storage device.

According to the exemplary embodiment illustrated in FIG. 5, an exemplary cargo/accessory 64 may be disposed in the cavity formed by an exemplary drop-down space 50A/B and adaptor 30/40 but have its own junctions 65 for coupling one or more additional cargo/accessories 70 thereto. In an exemplary aspect of this alternative embodiment, which may be illustrated through FIG. 5, additional cargo/accessories 70 may be coupled to the adaptor 30/40 or may be coupled to the junction 65 of the cargo/accessory 64 already disposed in the cavity created by the adaptor 30/40 and the drop-down space 50A/B. Thus, the disclosures herein further provide for additional robust coupling combinations that may be created by virtue of the stability enhancing arrangements caused by use of adaptors 40/30 and the drop-down spaces 50A/B with which they cooperatively engage, respectively.

As may be further illustrated in FIG. 2, an exemplary adaptor 30 may also create and/or expand the usable area of the drop-down space 50B through its work surfaces 31a and 31b. In an exemplary embodiment, work surfaces 31a/b and 41a/b may increase functionality and/or convenience by creating relatively flat surfaces on each side of the drop-down space 50B that can support cargo/accessories 70/80 or alternatively allow for other activities to take place. While adaptor 30 and 40 may be illustrated as exposing portions of drop-down space 50B and 50A, respectively, it is also possible that adaptors 30 and 40 may fully cover the drop-down space 50B and 50A, respectively, to create a larger support for accessories/cargo 70 or 80 and/or provide a larger work surface for needs.

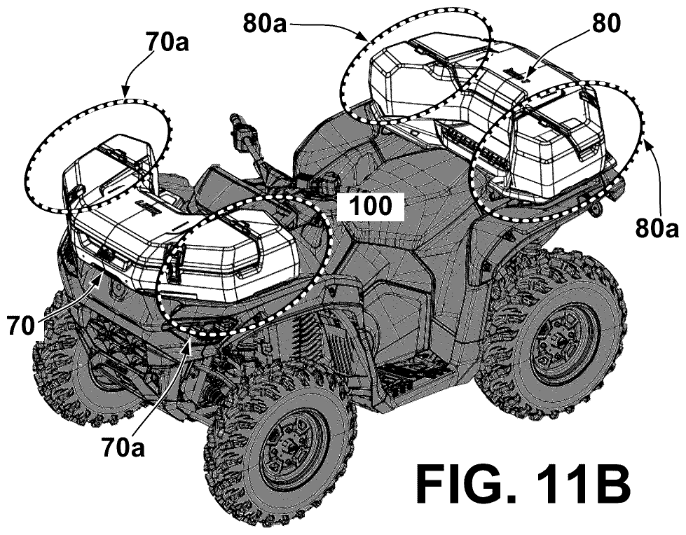

The combination of an exemplary adaptor 30 and drop-down space 50B in an exemplary vehicle 100 may create a stable cavity into which an exemplary cargo/accessory 46/60/64 may be placed and/or on top of which an exemplary secondary cargo/accessory 70 or 80 may be placed. Exemplary cargo/accessories 60 are stably held in such a cavity in FIGS. 5 and 9-10. Exemplary cargo/accessories 70 and/or 80 are stably held above the drop-down space 50B via the adaptors (30 or 40) once installed in vehicle 100. Alternatively, exemplary cargo/accessory 70 is stably held in drop-down space 50A while exemplary cargo/accessory 80 is stably held in drop-down space 50B, which can be seen with reference to FIGS. 11A-B.

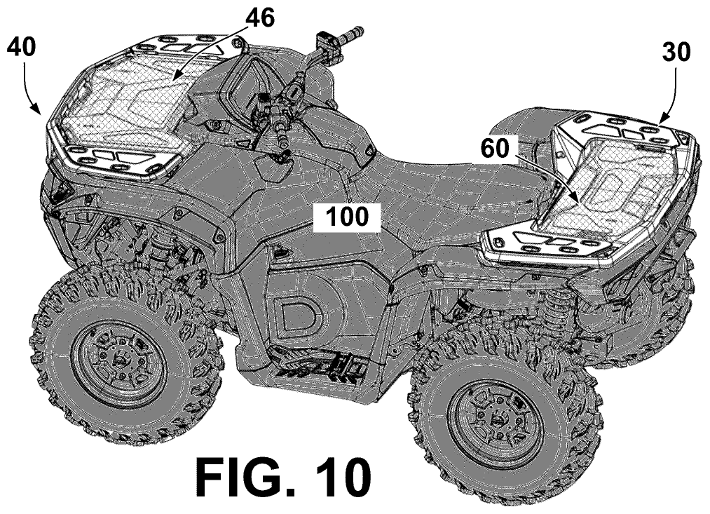

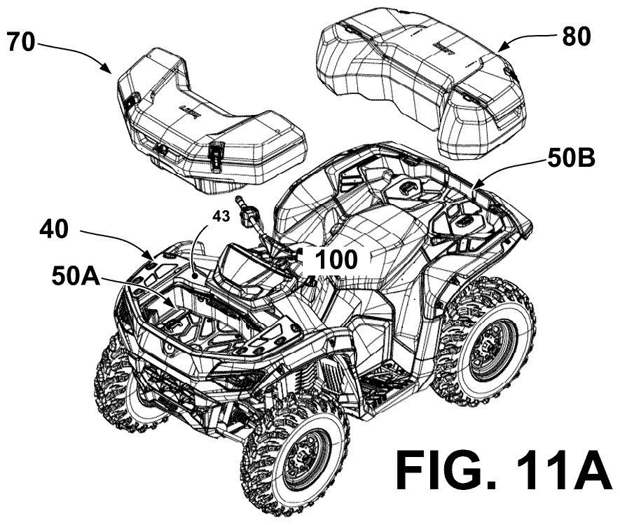

In accordance with the disclosures of FIG. 10, an exemplary cargo/accessory 60 may be disposed within the cavity formed by the combination of adaptor 30 and drop-down space 50B, yet an exemplary cargo/accessory 70 or 80 may be disposed atop the work surfaces 31a/b of adaptor 30 thereby concealing the cargo/accessory 60 stably held therein. For example, as illustrated in FIGS. 9-10, an upper surface of an exemplary cargo/accessory 60 may be substantially flush with the work surface 31a/b of an exemplary adaptor 30 to thereby permit further mounting of cargo/accessory 70 and/or 80 thereon via junctions 35 in adaptor 30. The same functionalities are achievable with respect to adaptors 40 installed in drop-down spaces 50A at the front of the vehicle 100 as well as the interconnections between cargo/accessories 46, 60, 64, 70, 80 and/or 90 via junctions 55/56 in the drop-down space 50A, work surfaces 41a/b in the adaptor 40, junctions 45 in adaptor 40, and/or junctions 65-66 on the cargo/accessory 60, junctions 85-86 on the cargo/accessory 80, as may be illustrated in FIGS. 11A-B, and 13. An exemplary junction 86 may be considered as a “toe-in” to correspond with receiving junction 66. For the sake of brevity, it should be understood to those skilled in the art that any permutation of cargo/accessory and drop-down space 50A and/or 50B is contemplated herein even if not expressly disclosed, including embodiments when the cargo/accessory is solely above the drop-down space 50A/B via the adaptor 40/30 or another supporting surface of previously-installed cargo/accessory (e.g., accessory junction 65), solely within the drop-down space 50A/B and/or below the adaptor 40/30 via junction 55 and any upwardly supported cargo/accessory(ies) 70, 80, and/or 90, and combinations of the same. An exemplary layout of possible permutations may be illustrated in exploded view via FIGS. 6B-C and 16.

As may be illustratively provided for in FIGS. 11A-B, exemplary accessories 70 and 80 may have an outer dimension that exceeds the outer dimension formed by the walls comprising drop-down spaces 50A and 50B, respectively. When such accessories 70 and 80 disposed in the drop-down space 50A and 50B, respectively, they may have one or more portions of their bodies 70a and 80a, respectively, extending beyond the walls comprising drop down spaces 50A and 50B, respectively. According to this exemplary embodiment, an exemplary drop-down space 50A/B may serve as a foundation for an otherwise larger accessory 70/80 that enables other portions of vehicle 100 to support or otherwise be located adjacent to the accessory 70/80 in and around portions 70a and/or 80a, respectively, when the accessory 70 and 80 is situated therein. In one advantageous embodiment, drop-down space 50B may be of sufficient depth and width to accommodate a complimentarily shaped portion of an accessory 80. Accordingly, the remainder of the accessory 80 may be multiple times larger than the drop-down space 50B to increase the volume of storage available for accessory 80. This advantageous arrangement may allow vehicles 100 to carry larger compartments on their bodies than previously capable using only junctions 55. In conjunction with the fortification provided by the walls of a drop-down space 50A/B, an exemplary drop-down space may be a more effective anchoring point for larger, heavier, and more dynamic accessories than if coupling were limited to just known anchoring arrangements on the cowling or frame of a vehicle 100.

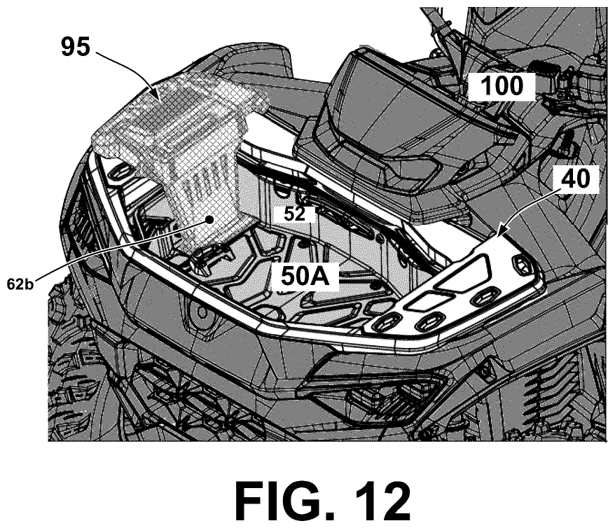

In an alternative embodiment, such as may be illustrated in FIG. 12, an exemplary cargo/accessory 46 may be purely held by the work surfaces 31a/31b but be of such a design that a portion 42b of the cargo/accessory 46 is disposed below the work surfaces 31a/31b. As a consequence of this exemplary aspect of the disclosures herein, an exemplary adaptor 30/40 may permit the stable containment of storage devices 46 that have larger volumes by virtue of the ability to stably hold such devices 46 on the adaptor 30/40 work surfaces 31a/41a/31b/41b above the drop-down space 50B/A but then enable the use of the vacant volume of the cavity formed by the combination of the drop-down space 50B/A and adaptor 30/40 located below the work surfaces 31a/41a/31b/41b.

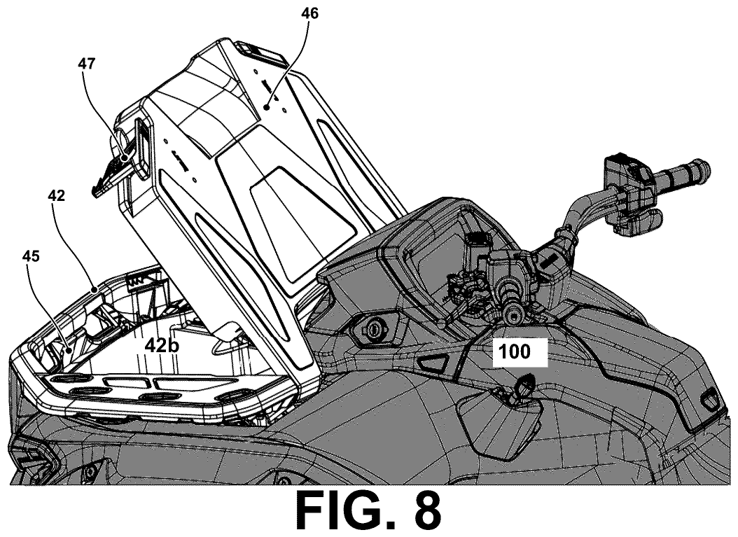

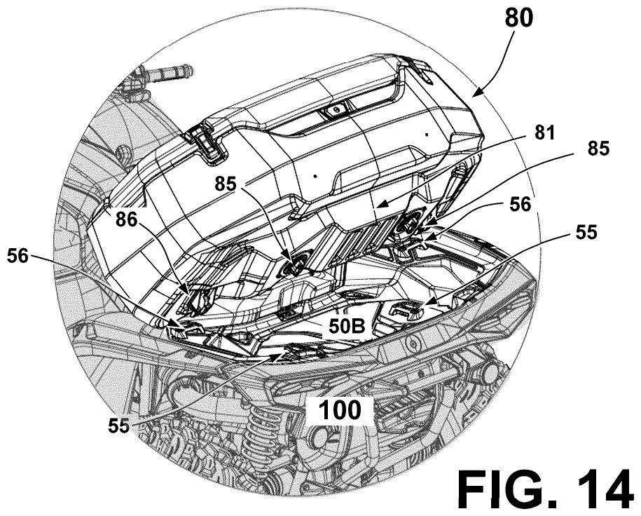

In yet another alternative embodiment, an exemplary cargo/accessory 70 may be illustrated in FIG. 7. According to this illustrative embodiment, an exemplary cargo/accessory 70 may possess a floor 71, walls 72, a front face 73, a lid 76, and a latch 77. Additionally, an exemplary cargo accessory may also comprise a lock mechanism 78/85 to allow the cargo/accessory 70 to couple to one or more junctions 55 in a drop-down space 50A/B of a vehicle 100 and/or junctions 35/45/65 found on the rear adaptor 30, forward adaptor 40, and accessories, such as accessory 60, respectively. In other words, a user may couple the cargo/accessory 70 to an adaptor 30/40 and/or another accessory 60 by an internal lock mechanism that enables stable coupling of the cargo/accessory 70 to one or more junctions 35/45/65 without having a line of sight to the latter junctions 35/45/65. While not shown, any of the exemplary accessories illustrated in any figures, including FIGS. 11 and 14, may possess such lock mechanisms 78/85. Thus, it is an exemplary aspect of the disclosures herein that an accessory 60, 70, 80, and/or 90 may be affixed to a junction 35/45/55/65 while the user is unable to see the interconnection formed between the latch mechanisms 47/77 or lock mechanisms 78/85, respectively.

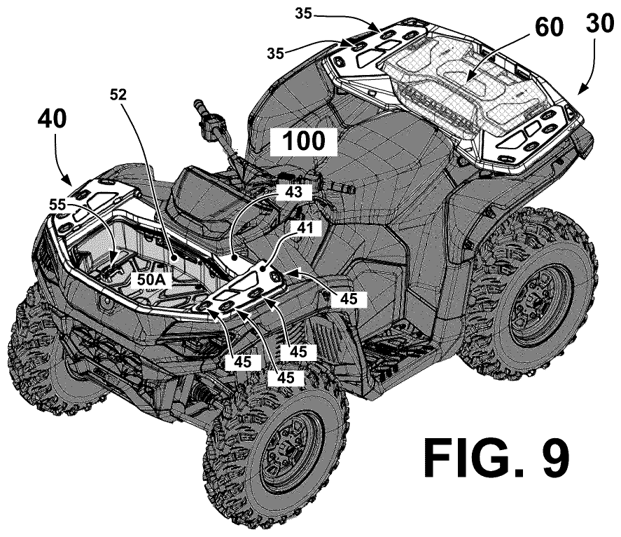

With reference to FIG. 8, an exemplary latch 47 may independently releasably connect lid 46 with respect to front bracket assembly 42 to provide a closing adaptor 40 for vehicle 100. In an alternative exemplary aspect, latch 47 may be configured to close the opening of an exemplary adaptor 30/40 via one of the junctions 35/45 in the work surfaces 31a/b and/or 41a/b, respectively. Thus, in one aspect, an exemplary adaptor 40 may have a closing mechanism (e.g., latch 47) to allow the adaptor 40 to hold such cargo/accessories 60 therein. It is contemplated that certain cargo/accessory 60 may become more useful or provide additionally utilities that did not exist in their separable modes by virtue of being attached to adaptors 30/40 or stored within latched lid mechanisms, such as latches 47 and lids 46.

Referring to the illustrative embodiment of FIG. 14, an exemplary drop-down space 50B in the rear of vehicle 100 may comprise a plurality of coupling mechanisms in the form of junctures 55 and 56. An exemplary cargo/accessory 80 may comprise on its lower surface a corresponding junction 85 and 86 for mechanically affixing the cargo/accessory 80 to the surfaces of the drop-down space 50B. In an exemplary embodiment, juncture 56 may operate by enclosing a toe-in connector 86 that is slid into the juncture 56 to allow the cargo/accessory 80 to be firmly affixed in place. Additionally, a Linq® attachment 85 on the cargo/accessory 80 may enable the robust connection to hold the cargo/accessory 80 in place against movement in drop-down space 50B via the corresponding Ling® anchor 55. As disclosed herein, any form and/or type of interconnecting/interoperable junctures 55/85 and 56/86 may be contemplated by the skilled artisan without departing from the concepts and teachings of the present disclosure.

The exemplary adaptors 30/40 disclosed herein may be made from various materials depending on their use applications and need for rigidity during vehicle 100 operation. As such, those skilled in the art may consider any material useful to withstand the loads, forces, and torques to be sustained by the vehicle 100 having the drop-down space 50 into which such adaptors 30/40 will be used as a possible material of manufacture to achieve the disclosures herein.

It is also contemplated in any of the aforementioned embodiments that the drop-down spaces 50A/B may be independently useful without the need for an adaptor 30/40 by virtue of the presence of junctions 55 in and around the floor 51 and/or walls 52 of the drop-down space 50. Adequately shaped cargo/accessories 60/64/70/80 can be stably mounted to particular drop-down spaces 50 via the junctions 55/56 and any junctions 65 that may be found on a particular cargo/accessory 60 disposed in the drop-down space 50. Thus, those skilled in the art would appreciate that a drop-down space 50 of a vehicle 100 comprising the features herein discussed, e.g., junctions 55, floor 51, walls 52, may be used to hold cargo/accessories 60/64/70/80 specifically designed to maximize/optimize/utilize the vacancy in the vehicle 100 created by the drop-down space 50A located at the front of the vehicle 100, drop-down space 50B at the rear of the vehicle 100, or both.

Many further variations and modifications may suggest themselves to those skilled in art upon referring to above disclosure and foregoing interrelated and interchangeable illustrative embodiments, which are given by way of example only, and are not intended to limit the scope and spirit of the interrelated embodiments of the invention described herein.

1. A recreational vehicle storage system, comprising:
a drop-down space defined by a plurality of walls internal of the vehicle and a floor that is located below an upper most surface of the seat of a vehicle, wherein the floor is located forward of the steering shaft of the vehicle; and
at least one coupling mechanism configured to releasably couple a first article thereto,
wherein the at least one coupling mechanism is found on either the floor, an adaptor configured to be interconnected to the vehicle, a work surface of the adaptor, or another article already disposed in the drop-down space.

2. The recreational vehicle storage system of claim 1, wherein at least one coupling mechanism is disposed on the floor.

3. The recreational vehicle storage system of claim 2, wherein at least one coupling mechanism is found on the adaptor, the adaptor comprising:
a forward bracket body configured to couple the adaptor to the vehicle proximate a first wall;
a rearward bracket body configured to couple the adaptor to the vehicle proximate a second wall, the first wall being opposite to the second wall; and
a pair of work surfaces interconnecting the forward bracket body to the rearward bracket body, wherein the forward bracket body, the rearward bracket body, and the pair of work surfaces circumscribe at least a portion of the drop-down space.

4. The recreational vehicle storage system of claim 2, wherein one of the pair of work surfaces comprises at least one coupling mechanism.

5. The recreational vehicle storage system of claim 2, wherein the adaptor comprises at least one other coupling mechanism for stably connecting a second article to the vehicle above the first article.

6. The recreational vehicle storage system of claim 2, wherein the first article is interconnected to the at least one coupling mechanism on the floor.

7. The recreational vehicle storage system of claim 1, wherein at least a portion of the first article is disposed above the drop-down space.

8. The recreational vehicle storage system of claim 7, wherein the first article is disposed above a second article in the drop-down space.

9. The recreational vehicle storage system of claim 8, wherein the first article is interconnected to the second article via at least one coupling mechanism on the second article.

10. The recreational vehicle storage system of claim 7, wherein the first article is disposed above the drop-down space via the work surface of the adaptor.

11. The recreational vehicle storage system of claim 6, wherein the first article has an outer dimension that extends beyond the outer dimension formed by the plurality of walls.

12. The recreational vehicle storage system of claim 1, wherein the first article is releasably couplable to either the floor, the plurality of walls, or the floor and the adaptor.

13. The recreational vehicle storage system of claim 1, wherein the first article is releasably couplable to only the adaptor.

14. The recreational vehicle storage system of claim 1, further comprising a second drop-down space defined by a plurality of walls internal of the vehicle and a floor that is located below the upper-most surface of the seat of the vehicle and rearward of the seat.

15. The recreational vehicle storage system of claim 1, wherein the floor stably connects the first article to the vehicle and the adaptor stably connects a second article above the first article.

16. The recreational vehicle storage system of claim 1, wherein the first article is configured to be bounded by a hood when the hood is aligned with the pair of work surfaces.

17. The recreational vehicle storage system of claim 1, wherein the floor stably connects a second article to the vehicle via the first article.

18. The recreational vehicle storage system of claim 14, further comprising a plurality of articles in addition to the first article, wherein at least one of the plurality of articles is disposed above or within the second drop-down space and at least one of the plurality of articles is disposed over the first article via an adaptor or a coupling mechanism on the first article.

19. The recreational vehicle storage system of claim 18, wherein a second adaptor circumscribes the second drop-down space, wherein the second adaptor comprises at least one coupling mechanism for stably connecting at least one of the plurality of articles above another of the at least one of the plurality of articles.

20. The recreational vehicle storage system of claim 18, wherein the at least one of the plurality of articles disposed within the second drop-down space interconnects at least one of the plurality of articles above the second drop-down space.
